(19) United States
(12) Patent Application Publication
(10) Pub. No.: US 2016/0031536 A1
(43) Pub. Date: Feb. 4, 2016

(54) BLACK BOX SYSTEM FOR LEISURE VESSEL

(71) Applicant: Bonc Inovators Co., Ltd, Mokpo-si Jeollanam-do (KR)

(72) Inventors: Yongsoo KIM, Gwangju (KR); Taejin HA, Gwangju (KR); Byoungguk MIN, Gwangju (KR); Jeongmin PARK, Seo-gu Gwangju (KR); Kyungok CHO, Jeollanam-do (KR); Sangin CHUN, Gwangju (KR)

(73) Assignee: Bonc Inovators Co., Ltd., Mokpo-si Jeollanam-do (KR)

(21) Appl. No.: 14/775,701

(22) PCT Filed: Aug. 22, 2013
(86) PCT No.: PCT/KR2013/007516

§ 371 Date: Sep. 13, 2015

(30) Foreign Application Priority Data
Mar. 14, 2013 (KR) 10-2013-0027287

(51) Int. Cl. B63B 49/00; B63B 45/00; G08G 3/00

(52) U.S. Cl. CPC B63B 49/00; G08G 3/00; B63B 45/00; B63B 2201/26; B63B 2203/00

(57) ABSTRACT

The present invention relates to a black box system for a leisure vessel and, more particularly, to a black box system for a leisure vessel which has a marine black box to interface a GPS receiving unit with various kinds of navigation data measuring devices and a camera unit, thereby checking problems in the vessel in real time, and which executes information stored in a portable memory with a marine black box application via a smart terminal to output the information on a display screen and to simultaneously store images and data at the time of an accident in a data storage server provided on land, thereby increasing portability and analyzing navigation data and images for a vessel when the vessel has been lost due to an unexpected accident.

### FIELD AND BACKGROUND OF THE INVENTION

The present invention relates to a black box system for a leisure vessel, and more particularly to a black box system for a leisure vessel, which constitutes an ocean black box and checks the problems in the vessel in real time by interfacing a GPS receiver, various navigation data measuring devices, and a camera unit, executes information stored in a portable memory of the ocean black box by means of an ocean black box application through a smart device and outputs on a display screen, and simultaneously stores video and data at the time of an accident in a data storage server installed on land, so that portability can be improved and navigation data and video of the accident vessel can be analyzed when the vessel is lost by an accident.

Recently, with the development of transportation facilities in a coastal area as well as an urban area, the national one-day life zone traffic culture is coming from a production area to consumers. Therefore, high quality products can be delivered from coastal areas to consumers in island areas.

Therefore, due to the increase of people who are engaged in a high value-added fishing industry including fishing nets, fish farm and the like and who enjoy various ocean leisure sports, that is to say, who experience marine culture like a sea fishing, island travel, etc., passenger ships or small ships (owner-driven ships) are increasingly operated as a marine transportation means of the island area.

Meanwhile, it was recommended in the SOLAS conference of parties in 1995 that a voyage data recorder (VDR) should be forcibly mounted on a passenger ship, and the subcommittee on Safety of Navigation (NAV) which is in the process of revising the SOLAS chapter V should review mounting requirements and performance criteria of the VDR in association with the subcommittee on Design and Equipment (DE). Northern European countries compel a vessel with a certain size or more to be equipped with a black box recording device.

As such, for the purpose of maintaining and managing the real time record of various data during the navigation of the vessel, the VDR installed in the vessel converts navigation data, engine state, weather information, etc., into a digital signal so as to make it possible for a signal converter to recognize and

transmits the converted digital signal to a main system, and then allows the transmitted data to be outputted in a desired form and automatically records the vessel navigation data, so that it is possible to reduce the conventional effort to keep a voyage log by hand and possible to construct an efficient operation management system. It has been discussed domestically for several years that the VDR should be forcibly installed.

Also, there is no objective measure for investigating the cause of an accident caused by other conditions, for example, vessel collision, etc., so that many troubles have occurred between the insurer and the insured. Therefore, there has been a constant requirement for objective data for investigating the cause of a vessel accident. Equipment such as a black box of an airplane is forcibly installed in the vessel and is used to provide objective base data for solving the above-mentioned problems. Also, an international organization has stipulated basic concepts of the black box for the vessel and the kind of data to be stored in the black box, so that it is necessary to activate the provision of the black box based on the stipulation.

In particular, in the application of the black box to a small vessel or a general vessel, it is not easy for an operator of the vessel to attach or detach the black box in the small vessel or general vessel. A technology is required which transmits a signal for help without a separate operation when a problem occurs in the small vessel or general vessel and transmits data corresponding to an emergency to a remote rescue center, thereby preventing the loss of evidence.

### SUMMARY OF THE INVENTION

The first object of the present invention is to provide a black box system for a leisure vessel, which constitutes an ocean black box and checks the problems in the vessel in real time by interfacing a GPS receiver, various navigation data measuring devices, and a camera unit, executes information stored in a portable memory of the ocean black box by means of an ocean black box application through a smart device and outputs on a display screen, and simultaneously stores video and data at the time of an accident in a data storage server installed on land, so that portability can be improved and navigation data and video of the accident vessel can be analyzed when the vessel is lost by an accident.

The second object of the present invention is to provide a black box system for a leisure vessel, which analyzes video frames acquired by a camera unit which acquires surrounding video information, recognizes an object appearing in the vicinity of an imaginary boundary line, analyzes the movement direction of the object, and identifies whether an abnormal situation occurs or not, so that it is possible to recognize in advance a collision with a neighboring vessel or an obstacle.

The third object of the present invention is to provide a black box system for a leisure vessel, which causes that only information at the time of the occurrence of the abnormal situation, the change of an altitude value, and occurrence of impact is stored in a separate portable memory, so that the portable memory corresponding to the necessity is separated and the information can be easily checked in an external computer terminal.

The fourth object of the present invention is to provide a black box system for a leisure vessel, which provides a submarine topographic map, thereby enabling an operator of the vessel to check a distance between the current location and a submarine topography with the naked eye. Therefore, it is possible to prevent a big accident from occurring due to collision of the vessel and an unrecognized submarine obstacle.

The technical solution of the present invention is provided to achieve the objective mentioned above.

According to an embodiment of the present invention, a black box system for a leisure vessel includes a navigation data measuring device 100 which provides a navigation data of a vessel; a camera unit 200 which acquires surrounding video information; an ocean black box 300 having a portable memory mounted thereon; and a smart terminal 400 which executes the information stored in the portable memory by means of an ocean black box application and outputs on a display screen.

### Advantageous Effects

The present invention provides a black box system for a leisure vessel, which constitutes an ocean black box and checks the problems in the vessel in real time by interfacing a GPS receiver, various navigation data measuring devices, and a camera unit, executes information stored in a portable memory of the ocean black box by means of an ocean black box application through a smart device and outputs on a display screen, and simultaneously stores video and data at the time of an accident in a data storage server installed on land. Therefore, portability can be improved and extensibility is provided which allows any smart terminal to be used. Besides, navigation data and video of the accident vessel can be analyzed when the vessel is lost by an accident, so that they can be used as legal evidence.

The present invention provides a black box system for a leisure vessel, which analyzes video frames acquired by a camera unit which acquires surrounding video information, recognizes an object appearing in the vicinity of an imaginary boundary line, analyzes the movement direction of the object, and identifies whether an abnormal situation occurs or not, so that it is possible to recognize in advance a collision with a neighboring vessel or an obstacle.

The present invention provides a black box system for a leisure vessel, which causes that only information at the time of the occurrence of the abnormal situation, the change of an altitude value, and occurrence of impact is automatically stored in a separate portable memory, so that the portable memory corresponding to the necessity is separated and the information can be easily checked in an external computer terminal.

The present invention provides a black box system for a leisure vessel, which provides a submarine topographic map, thereby enabling an operator of the vessel to check a distance between the current position and a submarine topography with the naked eye. Therefore, it is possible to prevent a big accident from occurring due to collision of the vessel and an unrecognized submarine obstacle.

### BRIEF DESCRIPTION OF THE SEVERAL VIEWS OF THE DRAWING(S)

FIG. 1 is a view showing an overall configuration of a black box system for a leisure vessel according to an embodiment of the present invention;

FIG. 2 is a block diagram showing an ocean black box of the black box system for a leisure vessel according to the embodiment of the present invention;

FIG. 3 is a block diagram of a smart terminal of the black box system for a leisure vessel according to the embodiment of the present invention; and

FIG. 4 shows an example of a screen of the smart terminal of the black box system for a leisure vessel according to the embodiment of the present invention.

### DESCRIPTION OF SPECIFIC EMBODIMENTS OF THE INVENTION

The present invention provides a black box system for a leisure vessel, which includes a navigation data measuring device 100 which provides a navigation data of a vessel;

a camera unit 200 which acquires surrounding video information;

an ocean black box 300 which includes: a vessel state communication unit 301 which receives vessel state information through the communication with the navigation data measuring device; a GPS receiver 302 which receives vessel location information of an operator from a GPS satellite; an electronic navigation chart database 303 which includes and stores a background shape of the ocean and text name data and a seaway network data; a measurement data acquisition unit 304 which acquires the vessel state information received by the vessel state communication unit; a marine weather information acquisition unit 305 which acquires marine weather information with reference to the vessel location information of the operator, received by the GPS receiver; a location mapping unit 306 which acquires the to location information from the GPS receiver and maps the current position onto the electronic navigation chart database; a video monitoring unit 307 which forms an imaginary boundary line in a surrounding video collected by the camera unit and recognizes an object appearing in the vicinity of the imaginary boundary line; a video analyzer 308 which analyzes the movement direction of the object recognized by the video monitoring unit and identifies whether an abnormal situation occurs or not; an impact sensor 309 which senses an impact; an altitude value analyzer 310 which acquires an altitude value from the GPS receiver and analyzes the change of the altitude value; a video information processing unit 311 which, at the time of the occurrence of the abnormal situation, the change of an altitude value, and occurrence of impact, acquires the surrounding video information acquired by the camera unit and the information mapped by the location mapping unit, and stores them in a video information database; a video information database 312 which stores the surrounding video information and the mapping information; a rescue signal transmitter 313 which, at the time of the occurrence of impact and the change of an altitude value, generates a rescue signal and transmits the signal to a rescue center; a separate storage processing unit 314 which, at the time of the occurrence of the abnormal situation, the change of an altitude value, and occurrence of impact, extracts the surrounding video information and the mapping information stored in the video information database and separately stores them in a portable memory; and a portable memory 315 which stores the information processed by the separate storage processing unit; and

a smart terminal 400 which executes the information stored in the portable memory by means of an ocean black box application and outputs on a display screen.

### Mode for Invention

Terms used in the present invention will be described as follows.

A general electronic navigation chart (ENC) is produced by National Oceanographic Research Institute. In the general ENC, ocean-related information including land and islands, lighthouse, dock, pier, port, reef, seaway, turning point, bathymetric map, anchorage, sunken vessel, fish farm, fishing zone, buoy, submarine cable, dangerous goods display, etc., has a structural type standardized in a digital format and contains numerical data. The ENC, which is called an electronic navigation table, refers to a maritime chart necessary to electronically display location information during the navigation of a vessel or airplane.

A bathymetric map data refers basically to information organized by storing ocean depth information in a database in the form of a numerical value and a coordinate system. The bathymetric map data is divided into a planar polygon data and a linear polyline data and is inputted and converted into a service data in order to represent undulating slopes and bathymetric topography, etc., with respect to the depth of sea.

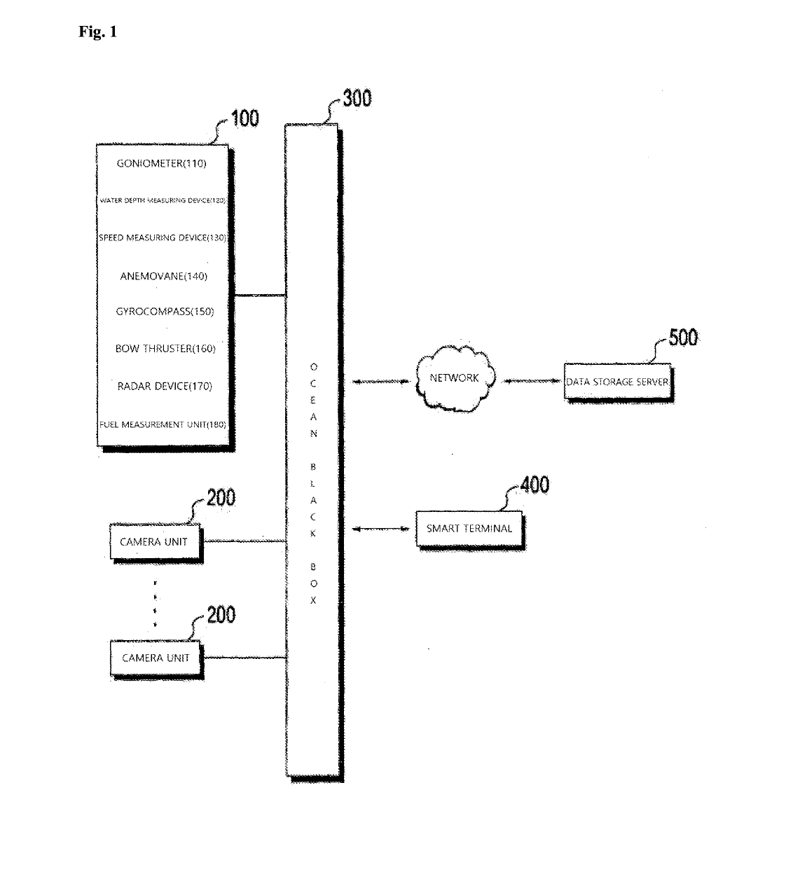

FIG. 1 is a view showing an entire configuration of a black box system for a leisure vessel according to an embodiment of the present invention.

The present invention provides a black box which is installed in a leisure vessel performing leisure activities along the coast because a wireless communication is readily performed between the coast and land.

As shown in FIG. 1, the black box system for a leisure vessel includes a navigation data measuring device 100 which provides a navigation data of a vessel; a camera unit 200 which acquires surrounding video information; an ocean black box 300 having a portable memory mounted thereon; and a smart terminal 400 which executes the information stored in the portable memory by means of an ocean black box application and outputs on a display screen.

Various kinds of measuring devices related to the navigation of the vessel, for example, a navigation related measuring device, an automation equipment, and a safety equipment, etc., are installed in a vessel.

The black box system for a leisure vessel according to the embodiment of the present invention records data provided by the above-mentioned measuring devices. The data is usefully applied to investigate the cause of a vessel accident. The configuration of the black box system for a leisure vessel includes the navigation data measuring device 100 which provides various kinds of navigation data of a vessel, and the ocean black box 300 which is connected to the system in a wired or wireless manner.

Also, a plurality of the camera units 200 are installed within the vessel at a certain interval in order to record and acquire video information surrounding the vessel.

A conventional black box for a vessel simply stores only the measurement data and a low readability. However, in the present invention, the plurality of camera units are provided to make it possible to objectively analyze video information corresponding to the accident and the measurement data by referencing them.

Also, the conventional black box for a vessel stores only the state information of the accident. However, the system according to the embodiment of the present invention allows an operator of the vessel to check a current state in real time by using the smart terminal and to transmit corresponding information to land by using a mobile communication network of the smart terminal.

That is, the smart terminal 400 executes the information stored in the portable memory of the ocean black box by means of an ocean black box application and outputs on a display screen.

Also, various information on the navigation is provided on the display screen through the ocean black box application. Direction, depth of the sea water, temperature of the sea water, speed, wind direction, wind speed, and whether or not lighting is operable, etc., are acquired from the measuring devices and displayed on the screen.

Accordingly, it is also possible to provide an advantage that ordinary navigation information as well as information on the accident can be easily confirmed through the smart terminal.

The ocean black box application may be downloaded from a homepage of a company providing the black box or from an app store (application store), etc., and installed. A server for download may be separately configured.

The app refers to an abbreviated form of an application (app) which is executed by the smart terminal.

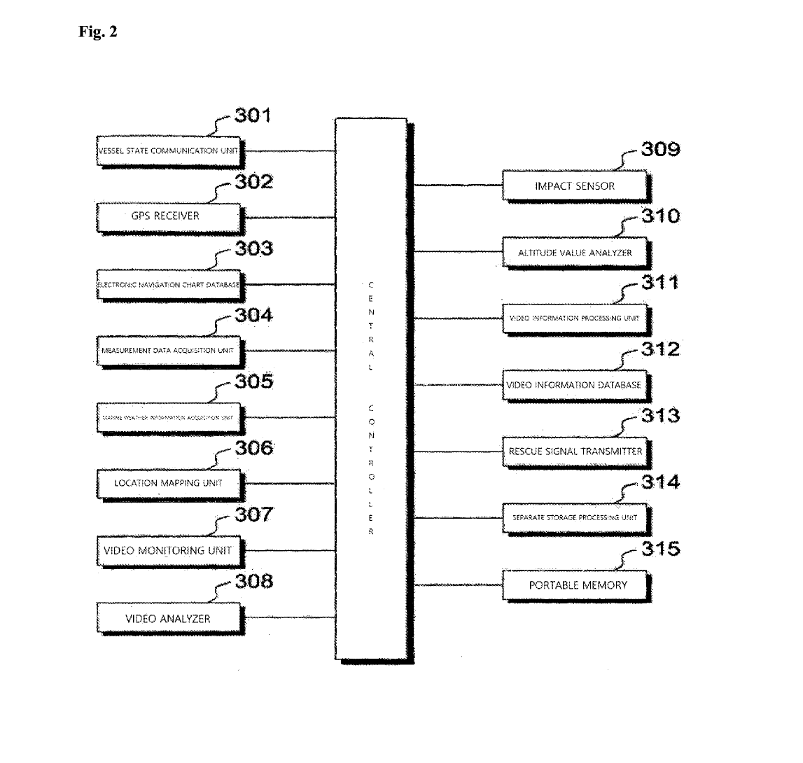

FIG. 2 is a block diagram showing the ocean black box of the black box system for a leisure vessel according to the embodiment of the present invention.

That is, the ocean black box 300 includes

a vessel state communication unit 301, a GPS receiver 302, an electronic navigation chart database 303, a measurement data acquisition unit 304, a marine weather information acquisition unit 305, a location mapping unit 306, a video monitoring unit 307, a video analyzer 308, an impact sensor 309, an altitude value analyzer 310, a video information processing unit 311, a video information database 312, a rescue signal transmitter 313, a separate storage processing unit 314, and a portable memory 315.

Next, the above components will be described in detail.

The vessel state communication unit 301 receives vessel state information through the communication with the navigation data measuring device.

That is, the vessel state communication unit performs a communication through a local area network or a wired network having a communication port with NMEA-0183 protocol. The vessel state communication unit receives a navigation data to be stored in the ocean black box.

Here, a vessel supporting the local area network performs an inter-device communication by using a communication network (Ethernet). A vessel which does not use the local area network performs a communication by using NMEA-0183 protocol that is a vessel electronic equipment standard communication protocol and transmits various data through the communication network to the ocean black box.

Also, the navigation data measuring device 100 includes a goniometer 110 which acquires azimuth information, a water depth measuring device 120 which measures the depth of the sea water, a speed measuring device 130 which measures a speed, an anemovane 140 which measures a wind direction and a wind speed, a gyrocompass 150 which measures an azimuth angle, a bow thruster 160 which measures the number of revolutions of a propeller, a radar device 170 which identifies an object within a certain range of a vessel in the navigation, and a fuel measurement unit 180 which measures the amount of fuel.

In other words, various kinds of measuring devices related to the navigation of the vessel, for example, a navigation related measuring device, an automation equipment, and a safety equipment, etc., are installed in a vessel.

Here, the ocean black box records data provided by the above-mentioned measuring devices. The data is usefully applied to investigate the cause of a vessel accident.

In addition to the above-mentioned measuring devices, an echo sounder may be included. The echo sounder launches a sound wave and measures a returning echo wave, and thus, observes the depth of the sea water and reef, etc. The speed measuring device 130 measures a speed. The gyrocompass 150 measures an azimuth angle. The anemovane 140 measures a wind direction and a wind speed. The bow thruster 160 measures the number of revolutions of a propeller. The radar device 170 identifies an object within a certain range of a vessel in the navigation.

Here, the data signal which is outputted from the measuring devices configured as above is simply stored in the black box through a communication network. Therefore, when the black box is lost or damaged due to a vessel accident, data on the vessel at the time of or to prior to the accident cannot be obtained at all, so that it is not possible to accurately analyze and judge the vessel accident.

Accordingly, in the present invention, the data signal which is outputted from the measuring device is stored in the ocean black box through a communication network. Simultaneously with this, the data signal is stored in the smart terminal and a data storage server installed on land.

Through this configuration, the data can be stored doubly and triply.

That is, the portable memory is mounted on the ocean black box and the smart terminal and the data is automatically stored in the portable memory, so that the data can be doubly stored.

Meanwhile, the fuel measurement unit is provided and measures the amount of fuel within the vessel. Then, the current amount of the fuel may be displayed on the screen of the smart terminal.

Generally, the kind of the data to be stored includes various navigation related data. That is, the current date and time, vessel location, speed, proceeding direction indicated by a compass of the vessel, communication content between the vessel and other base stations, radar data, depth of the sea water, alarm data, rudder angle order and execution, engine order and execution, opening and closing state of the vessel's body, the state of a watertight heat dissipation door, the vessel's body stress, weather information including a wind direction and a wind speed, etc., are data necessary for ensuring the safe navigation of the vessel. This information data is recorded doubly or triply in the ocean black box provided in the vessel itself, the data storage server installed on land, and the smart terminal owned by the operator, so that there is an effect of very usefully dealing with the loss of the vessel itself due to an accident.

The GPS receiver 302 receives vessel location information of the operator from a GPS satellite.

That is, the GPS receiver 302 receives the vessel location information of the operator from a GPS satellite. Specifically, the GPS receiver 302 includes a sensor and a receiving circuit which measures time point information, latitude and longitude coordinates and altitude information, movement direction and speed information, and the arrangement state of GPS satellites and signal strength.

The electronic navigation chart database 303 includes and stores a background shape of the ocean and text name data and a seaway network data. In general, voice and sound guide data which guides the seaway by voice and sound and manages warning sound files, icon and symbol data, and overall GUI design menu image data from an initial menu to a sub-menu are embedded in an electronic navigation chart database manager, the electronic navigation chart database, and an operational execution program.

Also, generally, the electronic navigation chart database 303 refers to an electronic navigation chart service data format which consists of a seaway network layer which generates a seaway network and a waterway through which general vessels pass and uses a waterway network to which attribute information has been assigned, so that navigation course search and seaway guide function are created, an ocean background shape layer which is constructed by distinguishing the bathymetric map and fish farm, fishing net information, seaway, etc., in the form of polygon and polyline, and by storing the information on the ocean depth, fish farm display, and seaway in a database in the form of a numerical map, a land area layer which detects the gulf of land and coast of peninsula, island area, etc., and allows a vessel to depart or enter a port or to determine its seaway through detouring, an ocean dangerous area layer which previously detects a cautious area including ocean reef and invisible rocks below the surface of the sea, a fishing area including a fish farm, a fishing net, etc., anchorage, sunken vessel areas, etc., from a certain distance, thereby making it possible for the vessel to avoid the obstacles to the vessel navigation and dangerous areas, and guiding the seaway navigation by automatically searching for the seaway in advance, and an ocean POI search layer which includes a lighthouse, dock, pier, port, passenger ship terminal, island travel information, fishing pointer, etc., which are helpful to the navigation guide to the operator.

Here, the electronic navigation chart database has a structure in which summary information like a distance by a seaway course, required time, course name, etc., is stored in a database in advance and an area apart from land or island coast toward the ocean at a certain distance is organized, together with a low depth area, as a safety area in order to generate a waterway through which only a small vessel can pass, so that structural editing is performed and attribute information is inputted.

Also, in order that the vessel can avoid the submarine obstacle area including the fish farm, reef, fishing net, etc., an area apart from the submarine obstacle area at a distance larger than a certain distance is stored as a waterway safety area network database and is used a seaway network data, the operator is able to recognize a plan as well as the summary information on the seaway course through the screen of the terminal.

The present invention makes use of the background shape of domestic coast and seaway network data which are based on an open API map of Google or Naver, to which the electronic navigation chart database has been applied.

That is, the important information (low data) of the electronic navigation chart is matched with a coordinate, so that common people are able to easily read the information. This is actively applied because 3G communication is possible in the coast of the country.

Therefore, not only a unique function of the black box, but also the navigation function through the smart terminal may be provided.

The measurement data acquisition unit 304 acquires the vessel state information received by the vessel state communication unit. The measurement data acquisition unit 304 may store the information in the memory or in the video information database.

The marine weather information acquisition unit 305 acquires marine weather information with reference to the vessel location information of the operator, received by the GPS receiver.

That is, while current wind speed, wind direction, direction, temperature, water temperature, altitude, coordinate, etc., are provided on the screen, the marine weather information acquisition unit 305 allows the operator to check the weather conditions of nearby ocean with reference to the vessel location information. Moreover, when an accident occurs, the marine weather information acquisition unit 305 allows the operator to objectively check whether the accident is caused by the weather conditions or by device failure within the vessel or other external causes.

This is because an accident which occurs in the vessel leads to a big accident, so that the accident cause should be thoroughly investigated and objective evidences should be presented in a legal battle which may occur in the future.

3G communication is possible in the coast of the country through use of the smart terminal. Therefore, the marine weather information of the coast can be acquired from the national weather service or the national maritime police agency by using 3G communication. The acquired weather information can be provided to the ocean black box. Also, the weather information may be acquired by configuring a communication module for wireless communication in the ocean black box.

The location mapping unit 306 acquires the location information from the GPS receiver and maps the current position onto the electronic navigation chart database. The location mapping unit 306 maps an ocean background data corresponding to the current location of the operator and guides the seaway by voice and screen.

Here, data read according to the processing of a central controller (reference numeral not shown) of the ocean black box is executed by an operational program, and then is controlled to be displayed on the screen.

Also, the video monitoring unit 307 is provided. The video monitoring unit 307 forms an imaginary boundary line in a surrounding video collected by the camera unit and recognizes an object appearing in the vicinity of the imaginary boundary line.

Here, the video analyzer 308 analyzes the movement direction of the object recognized by the video monitoring unit and identifies whether an abnormal situation occurs or not.

That is, the video monitoring unit is able to form an imaginary boundary line in a video collected by the camera unit and to recognize an object appearing in the vicinity of the imaginary boundary line. Since a technology of generating the imaginary boundary line is known to those skilled in the art, a detailed description thereof will be omitted.

The imaginary boundary line refers to an external boundary line according to a distance from the vessel. When an object moves inside the imaginary boundary line, the video analyzer 308 determines that an abnormal situation occurs. This is for analyzing the approach of other vessels or obstacles to the vessel.

Here, as shown in FIG. 4, the smart terminal connected to the ocean black box displays the location of each installed camera unit on the screen showing the shape of the vessel. When an abnormal situation occurs, the occurrence of the abnormal situation is displayed at the corresponding camera unit. The operator touches the occurrence, and then a window corresponding to the occurrence is shown.

The above-mentioned information is stored in the video information database 312 by the video information processing unit 311.

The impact sensor 309 senses an impact. The impact sensor 309 may include a gyro-sensor or a vibration sensor, etc. The impact sensor 309 senses the impact at the time of the vessel accident and captures the videos of the accident.

That is, the video information processing unit acquires the video information at the moment when the impact is sensed and stores in the video information database.

The altitude value analyzer 310 acquires an altitude value from the GPS receiver and analyzes the change of the altitude value.

That is, the altitude value can be extracted by the GPS receiver. Through the analysis of the change of the extracted altitude value, it is possible to check whether the vessel is sunk or not.

Therefore, when any one of the abnormal situation, impact, and altitude value change occurs, the video information processing unit 311 acquires the surrounding video information acquired by the camera unit and the information mapped by the location mapping unit, and automatically stores them in the video information database.

Meanwhile, the rescue signal transmitter 313 is provided. When any one of the impact and altitude value change occurs, the rescue signal transmitter 313 generates a rescue signal and transmits the signal to a rescue center.

That is, when an impact value is greater than an impact threshold value, it can be analyzed that the impact has occurred. Likewise, when a change of the altitude value is greater than a change threshold value, it can be analyzed that the vessel has been sunk.

Meanwhile, the separate storage processing unit 314 is provided to store the data and information in the portable memory which is one of the features of the present invention.

That is, at the time of the occurrence of the abnormal situation, the change of an altitude value, and occurrence of impact, the separate storage processing unit 314 extracts the surrounding video information and the mapping information stored in the video information database and separately stores them in the portable memory.

This intends allows the operator to easily separate only the light portable memory from the ocean black box and carry because the operator cannot carry the ocean black box at the time of the occurrence of the accident.

In general, a SD card is used as the portable memory. The information processed by the separate storage processing unit is recorded in the SD card in the form of a FAT16 file system. The FAT 16 format has been defined since DOS 4.0. Specifically, a storage space is divided into 65539 clusters and storing is performed. A general computer can read without a problem.

Also, the ocean black box 300 according to the embodiment of the present invention further includes an impact strength analyzer which sets levels based on the impact strength and provides a level value corresponding to the impact strength at the time of transmitting the rescue signal.

Generally, an accident can be determined by using an acceleration value generated when the accident occurs and a speed change value obtained by integrating the acceleration value. An accident level can be also set according to the impact strength of the accident.

Therefore, when an impact sensing value is greater than a threshold value, a level can be set according to the corresponding impact sensing value. For example, in a case where a threshold value is set to 5 and 5 to 20 is set as a level 1, 21 to 40 is set as a level 2, 41 to 60 is set as a level 3, 61 to 80 is set as a level 4, and 81 to 100 is set as a level 5, when the impact sensing value is 70, a level value of level 4 is transmitted together with the rescue signal. Then, a rescue center which receives them recognizes the seriousness of the accident in advance and then promptly takes follow-up measures subsequent to the seriousness.

Also, for the purpose of efficiently operating the system of the present invention by additional functions, a data storage server 500 which receives the data of the black box and stores may be further included on land.

That is, the smart terminal is used as a repeater which performs a communication relay between the ocean black box and the data storage server. A wireless mobile communication network may be used in the communication between the smart terminal and the data storage server.

Meanwhile, it is no wonder that a wireless communication module is added to the ocean black box, and thus, it is possible to communicate with the data storage server on land.

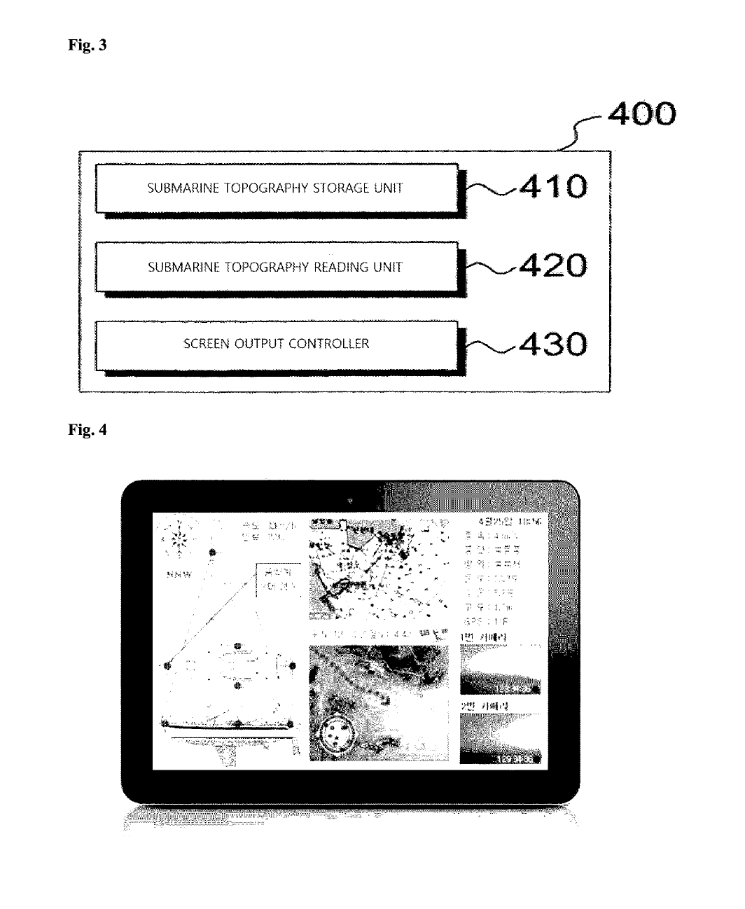

FIG. 3 is a block diagram of the smart terminal of the black box system for a leisure vessel according to the embodiment of the present invention.

According to an additional configuration, the smart terminal 400 includes

a submarine topography storage unit 410 which stores submarine topography data,

a submarine topography reading unit 420 which reads the submarine topography data matching the vessel location information of the operator, received by the GPS receiver, from the submarine topography storage unit, and

a screen output controller 430 which maps the vessel location information of the operator, received by the GPS receiver, onto the read submarine topography data, and controls to display on the screen.

That is, the submarine topography data is provided. Here, the submarine topography reading unit reads the submarine topography data matching the vessel location information of the operator, received by the GPS receiver, from the submarine topography storage unit.

That is, with reference to the current location information, the height of seabed can be checked in the form of graphics in real time by the smart terminal. The operator is able to check the seabed on the guide path to a destination through the screen. Therefore, an unexpected collision can be recognized in advance.

For this, the screen output controller controls maps the vessel location information of the operator, received by the GPS receiver, onto the read submarine topography data, and controls to display on the screen.

Therefore, the operator is able to check the distance between the current location and the submarine topography through a submarine topographic map, so that it is possible to prevent a big accident from occurring due to collision of the vessel and an unrecognized submarine obstacle.

This intends that the submarine topographic map is simultaneously provided so as to prevent the accident beforehand before the corresponding information is stored in the black box at the time of the accident, so that the vessel is safely protected from dangerous things existing in the sea and seabed.

According to the above configuration, it is possible to check the problems in the vessel in real time by interfacing the GPS receiver, various navigation data measuring devices, and camera unit, to execute information stored in the portable memory of the ocean black box by means of the ocean black box application through the smart device and outputs on the display screen, and to simultaneously store video and data at the time of the accident in the data storage server installed on land. Therefore, portability can be improved and extensibility is provided which allows any smart terminal to be used. Besides, navigation data and video of the accident vessel can be analyzed when the vessel is lost by an accident, so that they can be used as a legal evidence.

While the embodiment of the present invention has been illustrated and described, the present invention can be variously embodied without departing from the spirit and scope of the present invention, and it is obvious that the contents thereof are included in the right of the present invention.

### INDUSTRIAL AVAILABILITY

By applying the present invention to a vessel industry, navigation data and video of the accident vessel can be analyzed when the vessel is lost by an accident, so that they can be used as a legal evidence.

What is claimed is:

1. A black box system for a leisure vessel, the black box system comprising:
a navigation data measuring device 100 which provides a navigation data of a vessel;
a camera unit 200 which acquires surrounding video information;
an ocean black box 300 which comprises:
a vessel state communication unit 301 which receives vessel state information through the communication with the navigation data measuring device;
a GPS receiver 302 which receives vessel location information of an operator from a GPS satellite;
an electronic navigation chart database 303 which comprises and stores a background shape of the ocean and text name data and a seaway network data;
a measurement data acquisition unit 304 which acquires the vessel state information received by the vessel state communication unit;
a marine weather information acquisition unit 305 which acquires marine weather information with reference to the vessel location information of the operator, received by the GPS receiver;
a location mapping unit 306 which acquires the location information from the GPS receiver and maps the current position onto the electronic navigation chart database;
a video monitoring unit 307 which forms an imaginary boundary line in a surrounding video collected by the camera unit and recognizes an object appearing in the vicinity of the imaginary boundary line;
a video analyzer 308 which analyzes the movement direction of the object recognized by the video monitoring unit and identifies whether an abnormal situation occurs or not;
an impact sensor 309 which senses an impact;
an altitude value analyzer 310 which acquires an altitude value from the GPS receiver and analyzes the change of the altitude value;
a video information processing unit 311 which, at the time of the occurrence of the abnormal situation, the change of an altitude value, and occurrence of impact, acquires the surrounding video information acquired by the camera unit and the information mapped by the location mapping unit, and stores them in a video information database;
a video information database 312 which stores the surrounding video information and the mapping information;
a rescue signal transmitter 313 which, at the time of the occurrence of impact and the change of an altitude value, generates a rescue signal and transmits the signal to a rescue center;
a separate storage processing unit 314 which, at the time of the occurrence of the abnormal situation, the change of an altitude value, and occurrence of impact, extracts the surrounding video information and the mapping information stored in the video information database and separately stores them in a portable memory; and
a portable memory 315 which stores the information processed by the separate storage processing unit; and
a smart terminal 400 which executes the information stored in the portable memory by means of an ocean black box application and outputs on a display screen.

2. The black box system of claim 1, wherein the ocean black box 300 further comprises an impact strength analyzer which sets levels based on the impact strength and provides a level value corresponding to the impact strength at the time of transmitting the rescue signal, wherein the navigation data measuring device 100 comprises a goniometer 110 which acquires azimuth information, a water depth measuring device 120 which measures the depth of the sea water, a speed measuring device 130 which measures a speed, an anemovane 140 which measures a wind direction and a wind speed, a gyrocompass 150 which measures an azimuth angle, a bow thruster 160 which measures the number of revolutions of a propeller, a radar device 170 which identifies an object within a certain range of a vessel in the navigation, and a fuel measurement unit 180 which measures the amount of fuel.

3. The black box system of claim 1, wherein the smart terminal 400 comprises:
a submarine topography storage unit 410 which stores submarine topography data,
a submarine topography reading unit 420 which reads the submarine topography data matching the vessel location information of the operator, received by the GPS receiver, from the submarine topography storage unit, and
a screen output controller 430 which maps the vessel location information of the operator, received by the GPS receiver, onto the read submarine topography data, and controls to display on the screen.

4. The black box system of claim 1, further comprising a data storage server 500 which receives the data of the ocean black box and stores the data, wherein the smart terminal is used as a repeater which performs a communication relay between the ocean black box and the data storage server, and wherein a wireless mobile communication network is used in the communication between the smart terminal and the data storage server.
